(19) United States
(12) Patent Application Publication
(10) Pub. No.: US 2019/0205261 A1
(43) Pub. Date: Jul. 4, 2019

(54) SYSTEMS, METHODS, AND APPARATUSES FOR PATCHING PAGES

(71) Applicant: Intel Corporation, Santa Clara, CA (US)

(72) Inventor: David CHERITON, Palo Alto, CA (US)

(21) Appl. No.: 15/858,262

(22) Filed: Dec. 29, 2017

(51) Int. Cl. G06F 12/1036; G06F 9/455

(52) U.S. Cl. CPC G06F 12/1036; G06F 9/45558; G06F 2212/657; G06F 2212/151; G06F 2212/50; G06F 2009/45583

(57) ABSTRACT

Systems, methods, and apparatuses for patching pages are described. For example, a method comprising: allocating a small size page and initializing the small size page; adding the allocated and initialized small size page to a small size page table to reflect usage of a patch of the huge size page; and setting an indication of usage of the patch in a page entry associated with the huge size page is described.

### BACKGROUND

In computer systems, hardware memory mapping supports a specific set of virtual memory page sizes. For example, some processors support many different page sizes including 4 kilobyte pages, 2 Megabyte pages, 1 Gigabyte pages, 16 Gigabyte pages, etc. A common optimization in operating systems and virtual machine hypervisors is to support transparent page sharing. That is, two processes share a common physical memory page rather than having their own copy in memory. For example, in the Linux and Unix operating systems, when a first process forks, the second (new) process logically contains a complete copy of the address space of the first (original) process. However, rather than actually copy all of the pages, the operating system allows both processes to share access to the original set of pages. To make this transparent to the processes, the operating system write-protects these pages so that the operating system can intervene if either process attempts to write to such a shared page. Typically, the operating system intervenes by trapping on an attempted write to a shared page, copying the affected page, revising the page mapping of the writing process to reference this new (copied) page, and then allowing the write to complete on the copied page. This action is well-known as “copy-on-write” (COW).

### BRIEF DESCRIPTION OF DRAWINGS

Various embodiments in accordance with the present disclosure will be described with reference to the drawings, in which:

FIG. 1 is a schematic illustration of an embodiment of a computing system;

FIG. 2 illustrates an example of different virtual address spaces sharing a page frame;

FIG. 3 illustrates another example of different virtual address spaces sharing a page frame;

FIG. 4 illustrates an example of different virtual address spaces sharing a page frame that uses a patch for a modified page;

FIG. 5 illustrates an example of circuitry of a processor core that supports page patching;

FIG. 6 illustrates an embodiment of utilizing paging structures to determine whether a patch page is present;

FIG. 7 illustrates an embodiment of linear address translation to a 2 MB page using 4-level paging for patched pages;

FIG. 8 illustrates an example of a PDE for a 2 MB page supporting patches according to an embodiment;

FIG. 9 illustrates an embodiment of linear address translation to a 4 KB patch page using 4-level paging for patched pages;

FIG. 10 illustrates an embodiment of a huge size page TLB entry indicating patching;

FIG. 11 illustrates bitmask usage in an embodiment;

FIG. 12 illustrates an example of a TLB entry in a small size page TLB according to an embodiment;

FIG. 13 illustrates an embodiment of a method for a copy-on-write flow using patch pages during thread execution;

FIG. 14 illustrates an embodiment of a method for using patched pages in a MMU;

FIG. 15 is a block diagram illustrating both an exemplary in-order pipeline and an exemplary register renaming, out-of-order issue/execution pipeline according to embodiments of the invention;

FIGS. 16A-B illustrate a block diagram of a more specific exemplary in-order core architecture, which core would be one of several logic blocks (including other cores of the same type and/or different types) in a chip;

FIG. 17 is a block diagram of a processor 1700 that may have more than one core, may have an integrated memory controller, and may have integrated graphics according to embodiments of the invention;

FIG. 18 shown a block diagram of a system in accordance with one embodiment of the present invention;

FIG. 19 is a block diagram of a first more specific exemplary system in accordance with an embodiment of the present invention;

FIG. 20 is a block diagram of a second more specific exemplary system in accordance with an embodiment of the present invention;

FIG. 21 is a block diagram of a SoC in accordance with an embodiment of the present invention; and

FIG. 22 is a block diagram contrasting the use of a software instruction converter to convert binary instructions in a source instruction set to binary instructions in a target instruction set according to embodiments of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

With conventional small size pages, copy-on-write can be quite effective and efficient. However, the typical size of main memory and in-memory datasets has been growing significantly and is expected to continue to grow. Consequently, there is a trend to use larger page sizes. For example, the next larger size from a 4 kilobyte (KB) page is a 2 megabyte (MB) page (called a “huge size page” in this description, however, a huge size page is not limited to 2 MB and at least includes 1 gigabyte (GB) pages, 16 GB pages, etc.). Using huge size pages improves the translation lookaside buffer (TLB) hit rate, reduces the page table depth, and reduces the page table size.

However, using huge size pages significantly increases the cost in time and space of copy-on-write. For instance, with huge size pages, a process performing a write to a copy-on-write region incurs the cost of copying 512 times as much data and consuming 512 times as much memory as a result of the copy-on-write intervention.

Detailed herein are embodiments describing using huge size pages without incurring a substantially higher cost for copy-on-write through patching. A page with some desired modification (e.g., data change) appears to a specified set of processes as though it has been modified, but without with the patch. A patch is data associated with a range of addresses in a page which normally has some differences from the data in the original page. By “patching” a page, subsequent read and writes are mapped to the patch region of memory rather than to the underlying page.

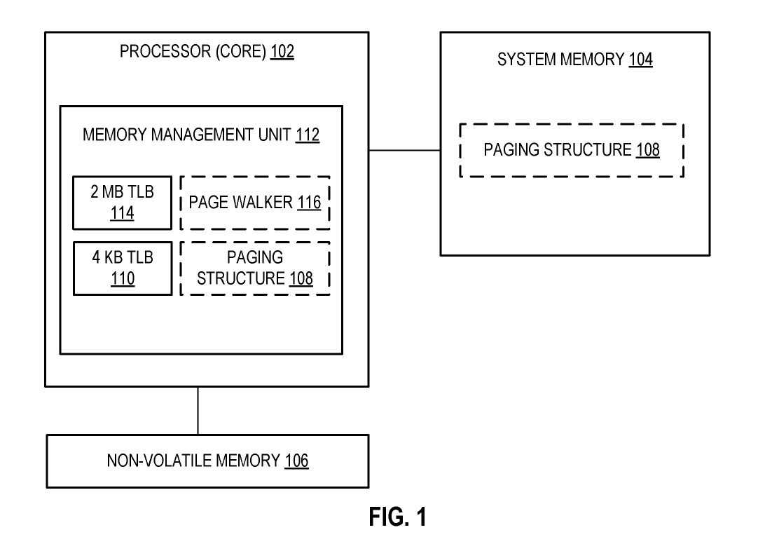

FIG. 1 is a schematic illustration of an embodiment of a computing system. The computing system may be or include, for example, a personal computer, a desktop computer, a mobile computer, a laptop computer, a notebook computer, a terminal, a workstation, a server computer, a network device, or other suitable computing device. The computing system includes a processor 102 that accesses one or memories via a paging system and may operate in accordance with embodiments of the invention. In addition, the computing system includes a system memory 104 and a nonvolatile memory 106 which is coupled to processor 102 via interconnects. Other components or logical elements may also be included in the computing system such as for example a peripheral bus or an input/output device.

System memory 104 may be or include, for example, any type of memory, such as static or dynamic random access memory. System memory 104 is used to store instructions to be executed by and data to be operated on by processor 102, or any such information in any form, such as for example operating system software, application software, or user data.

System memory 104 or a portion of system memory 104 (also referred to herein as physical memory) may be divided into a plurality of frames or other sections, wherein each frame may include a predetermined number of memory locations, e.g., a fixed size block of addresses. The setup or allocation of system memory 104 into these frames may be accomplished by for example an operating system or other unit or software capable of memory management. The memory locations of each frame may have physical addresses that correspond to linear (virtual) addresses that may be generated by for example processor 102. To access the correct physical address, the linear address is translated to a corresponding physical address. This translation process may be referred to herein as paging or a paging system. In some embodiments of the present invention, the number of linear addresses may be different, e.g., larger than those available in physical memory. The address conversion information of a linear address may be stored in a page table entry. In addition, a page table entry may also include information concerning whether the memory page has been written to, when the page was last accessed, what kind of processes (e.g., user mode, supervisor mode) may read and write the memory page, and whether the memory page should be cached. Other information may also be included.

In one embodiment, pages in memory are of different sizes such as for example 4 Kbytes and 2 Mbytes, and different parts of memory may be assigned to each of these page sizes. Other numbers of pages sizes and allocations of memory are possible. Nonvolatile memory 106 may be or include, for example, any type of nonvolatile or persistent memory, such as a disk drive, semiconductor-based programmable read only memory or flash memory. Nonvolatile memory 106 may be used to store any instructions or information that is to be retained while the computing system is not powered on. In alternative embodiments, any memory beyond system memory (e.g., not necessarily non-volatile) may be used for storage of data and instructions.

As part of a translation caching scheme, the processor 102 may include a memory management unit (MMU) 112 including a TLB for each page size in system memory 104. Incorporating TLBs into processor 102 may enhance access speed, although in some alternative embodiments these TLBs may be external to processor 102. TLBs may be used in address translation for accessing a paging structure 108 stored in system memory 104 such as for example a page table. Alternatively, paging structure 108 may exist elsewhere such as in a data cache hierarchy. The embodiment shows two TLBs: a 4 Kbyte TLB 110 and a 2 Mbyte TLB 114, although other TLBTs corresponding to the various page sizes present in system memory 104 may also be used. Additionally, as detailed below, there may be multiple TLBs per page size to account for patching.

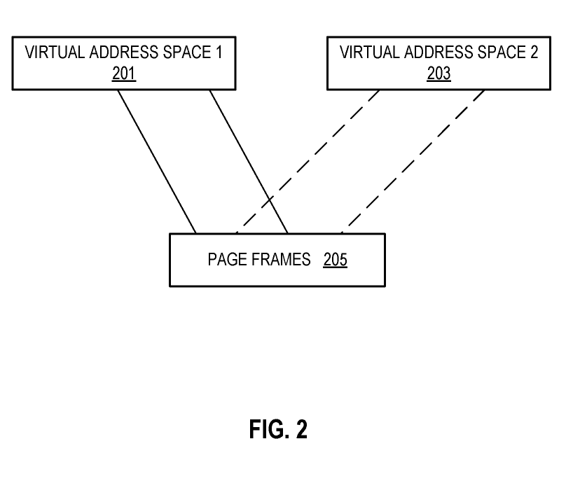

As used herein, a TLB may be or include a cache or other storage structure which holds translation table entries recently used by processor 102 that map virtual memory pages (e.g., having linear or non-physical addresses) to physical memory pages (e.g., frames). In the embodiment of FIG. 2, each TLB may be set-associative and may hold entries corresponding to the respective page size indicated. Alternatively, a single fully associative TLB for all page sizes may also be implemented. Other numbers of page sizes with corresponding different TLB entries may be used. Further different TLBs may be used to cache different information such as for example instruction TLBs and data TLBs.

Although TLBs are used herein to denote such caches for address translation, the invention is not limited in this respect. Other caches and cache types may also be used. In some embodiments, the entries in each TLB may include the same information as a corresponding page table entry with an additional tag, e.g., information corresponding to the linear addressing bits needed for an address translation. Thus, each entry in a TLB may be an individual translation as referenced by for example the page number of a linear address. For example, for a 4 Kbyte TLB entry, the tag may include bits of the linear address. The entry in a TLB may contain the page frame, e.g., the physical address in the page table entry used to translate the page number. Other information such as for example “dirty bit” status may also be included.

Processor 102 may cache a TLB entry at the time it translates a page number to a page frame. The information cached in the TLB entry may be determined at that time. If software such as for example a running application modifies the relevant paging-structure entries after this translation, the TLB entry may not reflect the contents of the paging-structure entries.

When a linear address requires translation such as for example when an operating program must access memory for an instruction fetch or data fetch, the memory management part of operating system software executing or circuitry 112 operating on processor 102 or elsewhere in computing system 100 may search for the translation first in all or any of the TLBs. If the translation is stored in a TLB, a TLB hit may be generated, and the appropriate TLB may provide the translation. If processor 102 cannot find an entry in any of TLBs, a TLB miss may be generated. In this instance, a page table walker 116 (either a hardware version in the MMU, or a software version called by the OS) may be invoked to access the page tables and provide the translation. As used herein, a page table walker is any technique or unit for providing a translation when another address translation unit (such as a TLB) cannot provide the translation such as for example by accessing the paging structure hierarchy in memory. Techniques for implementing such a page table walker that can accommodate the page sizes as described herein for embodiments of the invention are known in the art.

FIG. 2 illustrates an example of different virtual address spaces sharing a page frame. As illustrated, virtual address space 1 201 and virtual address space 2 203 share portions of page frame 205. This is shown as an overlap into the page frame 205. In this example, when there is a change to data in the shared portion of the page frame 205, a COW occurs.

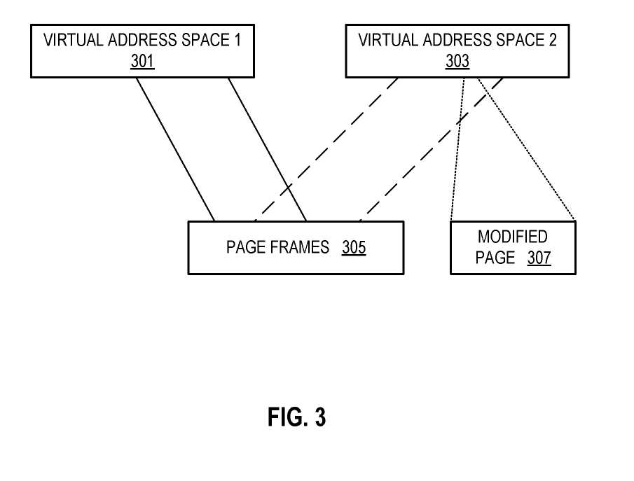

FIG. 3 illustrates another example of different virtual address spaces sharing a page frame. As illustrated, virtual address space 1 301 and virtual address space 2 303 share portions of a page frame 305. This is shown as an overlap into the page frame 305. In this example, when there is a change to data in the shared portion of the page frame 305, a modified page 307 is created. As detailed, the use of a modified page 307 uses a COW.

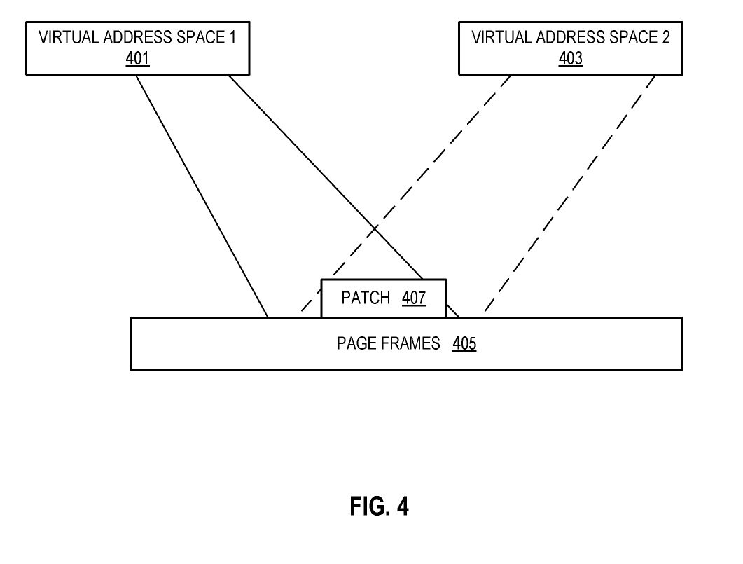

FIG. 4 illustrates an example of different virtual address spaces sharing a page frame that uses a patch for a modified page. As illustrated, virtual address space 1 401 and virtual address space 2 403 share portions of a page frame 405. This is shown as an overlap into the page frame 405. In this example, when there is a change to data in the shared portion of the page frame 405, a patch 407 is created. The patch 407 is to be used in lieu of the page frame 305 for that address.

A patch may be indicated as writable, having been modified, accessed, and so on. In an embodiment, the patch is a virtual memory page (in size and alignment) as supported by the computer system. The underlying page is typically a larger page size. For example, in some processor architectures, the patch page is small size page (e.g., a 4 KB page) and the underlying page would be a huge size page, i.e., 2 MB, 1 GB or 16 GB.

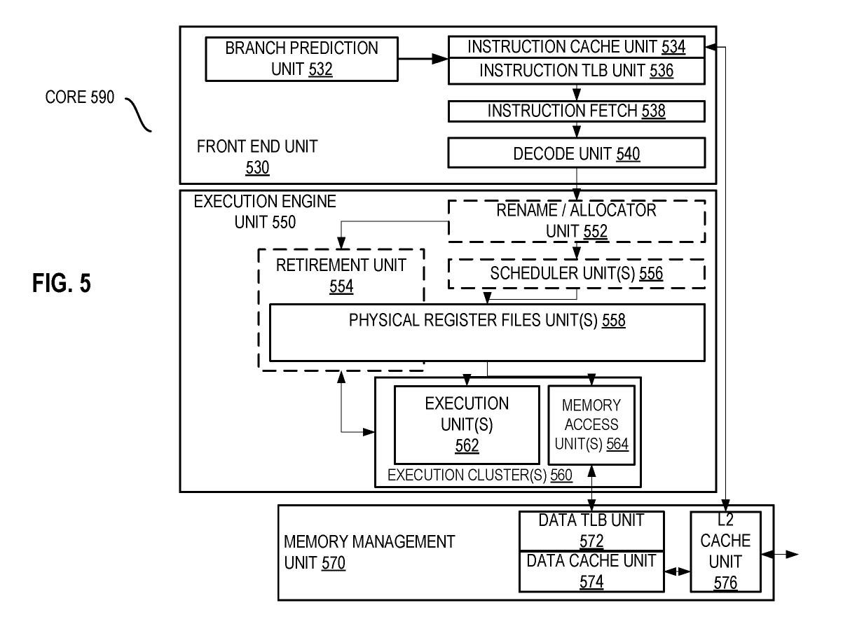

FIG. 5 illustrates an example of circuitry of a processor core that supports page patching. The core 590 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.)), including the instruction(s) described herein. In one embodiment, the core 590 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, register renaming may be used in an in-order architecture. While the illustrated embodiment of the processor also includes separate instruction and data cache units 534/574 and a shared L2 cache unit 576, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all the cache may be external to the core and/or the processor.

A processor core 590 including a front end unit 530 is coupled to an execution engine unit 550, and both are coupled to memory management unit circuitry 570. The core 590 may be a reduced instruction set computing (RISC) core, a complex instruction set computing (CISC) core, a very long instruction word (VLIW) core, or a hybrid or alternative core type. As yet another option, the core 590 may be a special-purpose core, such as, for example, a network or communication core, compression engine, coprocessor core, general purpose computing graphics processing unit (GPGPU) core, graphics core, or the like.

The front end unit 530 includes a branch prediction unit 532 coupled to an instruction cache unit 534, which is coupled to an instruction TLB 536, which is coupled to an instruction fetch unit 538, which is coupled to a decode unit 540. The decode unit 540 (or decoder) may decode instructions, and generate as an output one or more micro-operations, micro-code entry points, microinstructions, other instructions, or other control signals, which are decoded from, or which otherwise reflect, or are derived from, the original instructions. The decode unit 540 may be implemented using various different mechanisms. Examples of suitable mechanisms include, but are not limited to, look-up tables, hardware implementations, programmable logic arrays (PLAs), microcode read only memories (ROMs), etc. In one embodiment, the core 590 includes a microcode ROM or other medium that stores microcode for certain macroinstructions (e.g., in decode unit 540 or otherwise within the front end unit 530). The decode unit 540 is coupled to a rename/allocator unit 552 in the execution engine unit 550.

The execution engine unit 550 includes the rename/allocator unit 552 coupled to a retirement unit 554 and a set of one or more scheduler unit(s) 556. The scheduler unit(s) 556 represents any number of different schedulers, including reservations stations, central instruction window, etc. The scheduler unit(s) 556 is coupled to the physical register file(s) unit(s) 558. Each of the physical register file(s) units 558 represents one or more physical register files, different ones of which store one or more different data types, such as scalar integer, scalar floating point, packed integer, packed floating point, vector integer, vector floating point, status (e.g., an instruction pointer that is the address of the next instruction to be executed), control registers, etc. In one embodiment, the physical register file(s) unit 558 comprises a vector registers unit and a scalar registers unit. These register units may provide architectural vector registers, vector mask registers, and general purpose registers. The physical register file(s) unit(s) 558 is overlapped by the retirement unit 554 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 554 and the physical register file(s) unit(s) 558 are coupled to the execution cluster(s) 560. The execution cluster(s) 560 includes a set of one or more execution units 562 and a set of one or more memory access units 564. The execution units 562 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 556, physical register file(s) unit(s) 558, and execution cluster(s) 560 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 564). It should also be understood that where separate pipelines are used, one or more of these pipelines may be out-of-order issue/execution and the rest in-order.

The set of memory access units 564 is coupled to the memory unit 570, which includes a data TLB unit 572 coupled to a data cache unit 574 coupled to a level 2 (L2) cache unit 576. In one exemplary embodiment, the memory access units 564 may include a load unit, a store address unit, and a store data unit, each of which is coupled to the data TLB unit 572 in the memory unit 570. The instruction cache unit 534 is further coupled to a level 2 (L2) cache unit 576 in the memory unit 570. The L2 cache unit 576 is coupled to one or more other levels of cache and eventually to a main memory. The memory management unit QA7E0 may also include circuitry used to calculate a physical address using page tables, etc.

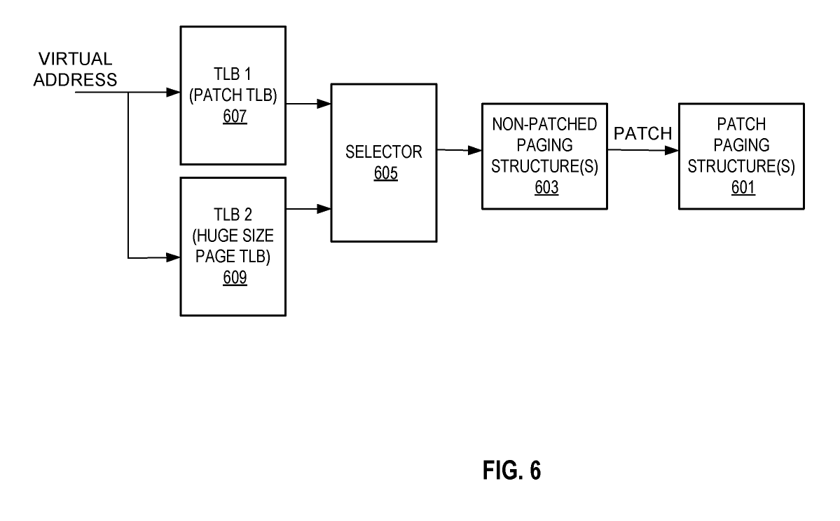

FIG. 6 illustrates an embodiment of utilizing paging structures to determine whether a patch page is present. As shown, there is at least one patch paging structure for patched pages 601 and at least one patch paging structure for non-patched pages 603. There may be paging structures per page size mapping (e.g., per 4 KB pages and huge size pages). Additionally, in some embodiments, there are separate 4 KB patch paging structures per process and/or thread. In some embodiments, the paging structures are cached in a core. In some embodiments, the paging structures are stored in memory (e.g., main memory).

A selector 605 receives the outputs from a first TLB structure 607 (“patch TLB”) and a second TLB structure 609 (“huge size page TLB”) to decide if there should be usage of a paging structure. The paging structures 601, 603 utilize page table mappings and have a multiplicity of page tables per process, one to indicate the mapping of “conventional” mappings of virtual addresses for a process to the corresponding pages (603) and another to map virtual addresses to patches (601).

When there is an indication of a patch in the non-patched paging structure(s) 603, then a lookup is made in the patch paging structure(s) 601 to obtain an address. Otherwise, the non-patched paging structure 603 is used to obtain an address.

In some embodiments, the patch page table uses conventional radix tree representation of the page mapping. Alternatively, the patch page table uses an inverted page table, recognizing the sparsity of the expected patches.

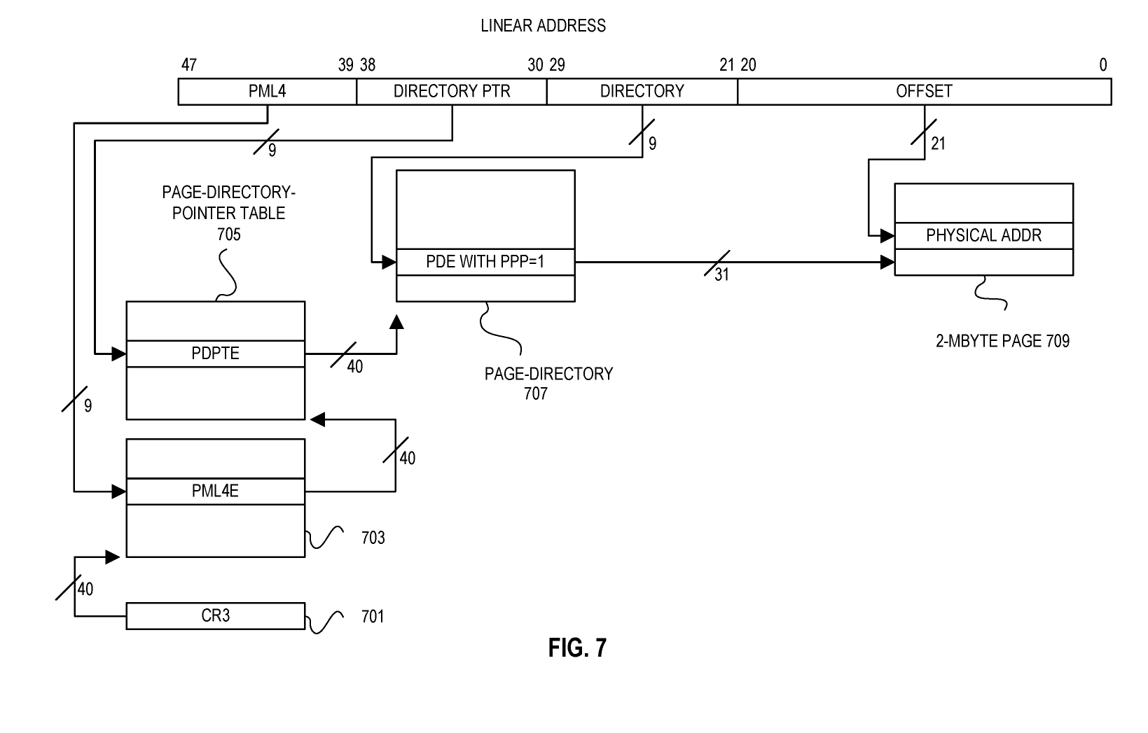

FIG. 7 illustrates an embodiment of linear address translation to a 2 MB page using 4-level paging for patched pages. In some embodiments, the components detailed herein are circuits inside of a memory management unit and are a part of, or utilized, by a page walker. A control register 701 (called CR3 in this example) stores the upper bits (e.g., upper 40 bits) of an address of a PML4 entry (PML4E) in PML4 (page map level 4) table 703. The next bits of the PML4E entry come from bits 47:39 of the linear address. As such, the PML4E address is defined, in some embodiments with bits 51:12 from CR3B 701, bits 11:3 from bits 47:39 of the linear address, and bits 2:0 set to all 0. Because a PML4E is identified using bits 47:39 of the linear address, it controls access to a 512-GByte region of the linear-address space.

A 4-KB naturally aligned page-directory-pointer table 705 is located at the physical address specified in bits 51:12 of the PML4E. A page-directory-pointer table comprises 512 64-bit entries (PDPTEs). A PDPTE is selected using the physical address defined as follows: bits 51:12 are from the PML4E, bits 11:3 are bits 38:30 of the linear address, and bits 2:0 are all 0. Because a PDPTE is identified using bits 47:30 of the linear address, it controls access to a 1-GB region of the linear-address space.

A page directory 707 comprises 512 64-bit entries (PDEs). A PDE is selected using the physical address defined as follows: bits 51:12 are from the PDPTE, bits 11:3 are bits 29:21 of the linear address, and bits 2:0 are all 0. Because a PDE is identified using bits 47:21 of the linear address, it controls access to a 2-MB region of the linear-address space.

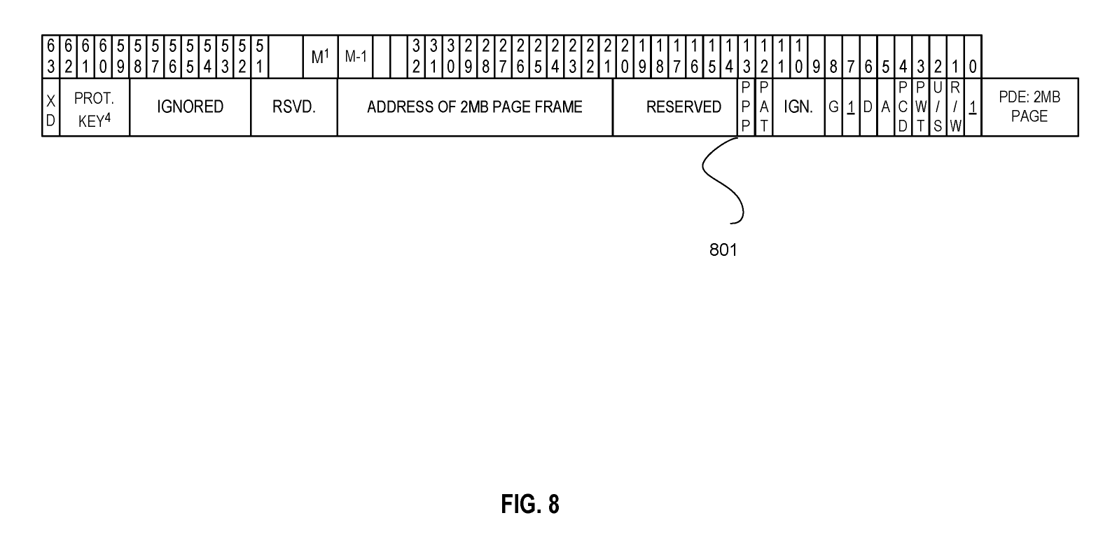

FIG. 8 illustrates an example of a PDE for a 2 MB page supporting patches according to an embodiment. In some embodiments, each PDE includes a patch page present (PPP) field 801 (shown here as being at bit 13 although other bits could be used) indicating that there is a patch to be applied. If this bit is not set, then there is no patch and the “conventional” paging structure should be used.

The final physical address 709, if applicable, is computed as follows: bits 51:21 are from the PDE and bits 20:0 are from the original linear address.

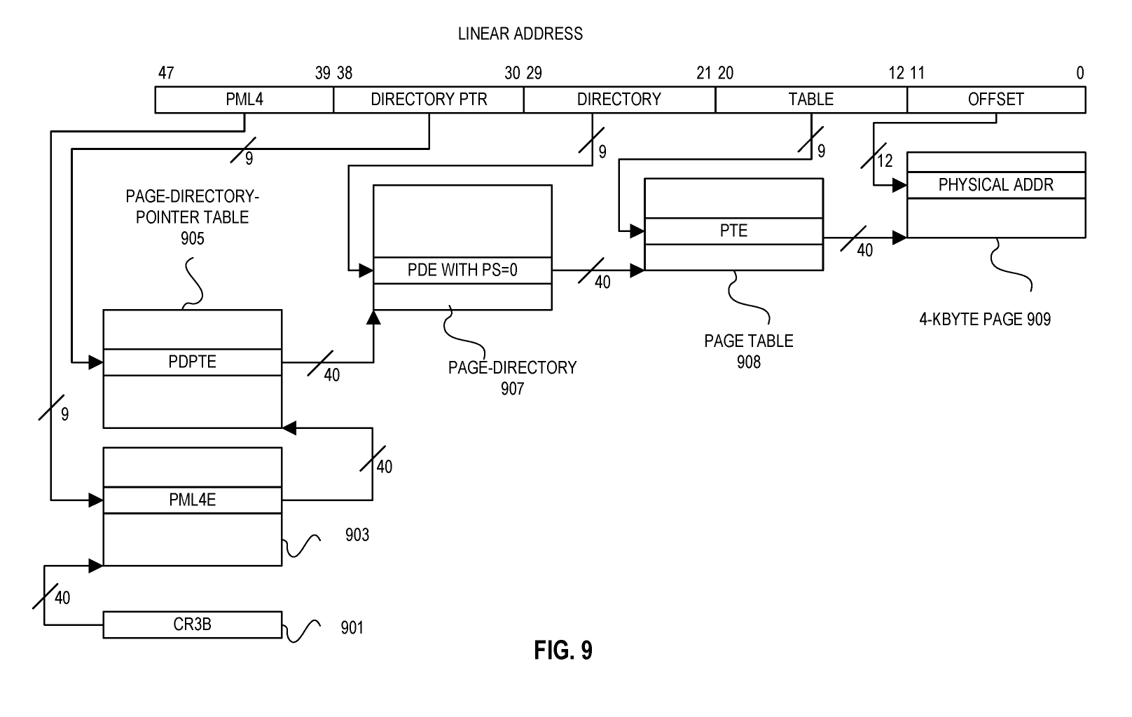

FIG. 9 illustrates an embodiment of linear address translation to a 4 KB patch page using 4-level paging for patched pages. In some embodiments, the components detailed herein are circuits inside of a memory management unit and are a part of, or utilized, by a page walker.

A control register 901 (called CR3B in this example) stores the upper bits (e.g., upper 40 bits) of an address of a PML4 entry (PML4E) in PML4 (page map level 4) table 903. The next bits of the PML4E entry come from bits 47:39 of the linear address. As such, the PML4E address is defined, in some embodiments with bits 51:12 from CR3B 901, bits 11:3 from bits 47:39 of the linear address, and bits 2:0 set to all 0. Because a PML4E is identified using bits 47:39 of the linear address, it controls access to a 512-GByte region of the linear-address space.

A 4-KB naturally aligned page-directory-pointer table 705 is located at the physical address specified in bits 51:12 of the PML4E. A page-directory-pointer table comprises 512 64-bit entries (PDPTEs). A PDPTE is selected using the physical address defined as follows: bits 51:12 are from the PML4E, bits 11:3 are bits 38:30 of the linear address, and bits 2:0 are all 0. Because a PDPTE is identified using bits 47:30 of the linear address, it controls access to a 1-GB region of the linear-address space.

A page directory 907 comprises 512 64-bit entries (PDEs). A PDE is selected using the physical address defined as follows: bits 51:12 are from the PDPTE, bits 11:3 are bits 29:21 of the linear address, and bits 2:0 are all 0.

In some embodiments, if a page size flag in the PDE is set to certain value (e.g., PS flag is 0), a 4-KByte naturally aligned page table 908 is located at the physical address specified in bits 51:12 of the PDE. The page table 908 comprises 512 64-bit entries (PTEs). A PTE is selected using the physical address defined as follows: bits 51:12 are from the PDE, bits 11:3 are bits 20:12 of the linear address, and bits 2:0 are all 0.

The final physical address 909 is computed as follows: bits 51:12 are from the PTE and bits 11:0 are from the original linear address.

In some embodiments, the processor utilizes at least one TLB that supports patch pages. As shown in FIG. 6, there is at least one TLB for patch pages 607 and a TLB for unpatched pages 609. In an embodiment, there are separate TLBs for small size pages (e.g., 4 K pages) and huge size pages. In other embodiments, a single TLB is used. A virtual address is looked up in both TLBs 607, 609. An entry in the small size page TLB 607 is used when present (indicating a patch) and otherwise an entry from the huge size page TLB 609 is used. In some embodiments, it is required to ensure that the mapping performed by the TLBs is consistent with the use of page tables as detailed above. In particular, when a huge size page is patched at the virtual address, the TLB maps the virtual address to the patch page, not the huge size page.

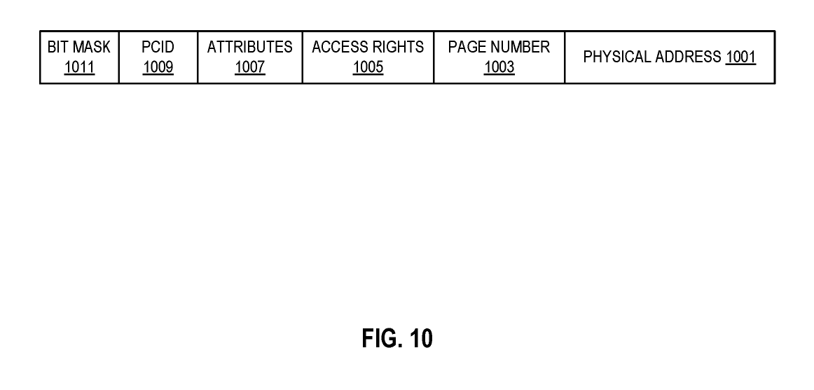

In an embodiment, there is a bit mask in each huge size page TLB entry indicating regions of the huge size page that have been patched. FIG. 10 illustrates an embodiment of a huge size page TLB entry indicating patching. As illustrated, the TLB entry includes fields for a physical address 1001 corresponding to the page number 1003, access rights information 1005 (e.g., read/write information, supervisor/user mode information, execution disable information, etc.), attributes 1007 (e.g., a dirty flag and memory type), and a process-context identifier (PCID) 1009.

Additionally, the huge size page TLB entry includes a bit mask 1011. For example, when the i-th bit in the bit mask is 1, this indicates that there is a patch in the i-th region of this huge size page. Using a bit mask 1011, on lookup of a virtual address, if there is a miss in the small size page TLB and the virtual address falls in a region of a huge size page that has been patched as indicated by this huge size page bit mask, the actual patch is determined from the page tables using a page table walker (as detailed). In particular, the page table walker locates the patch pages in the 4K patch page table (e.g., as detailed in FIG. 9) and makes those available to the translation, typically loading this information into the small size page TLB for subsequent accesses.

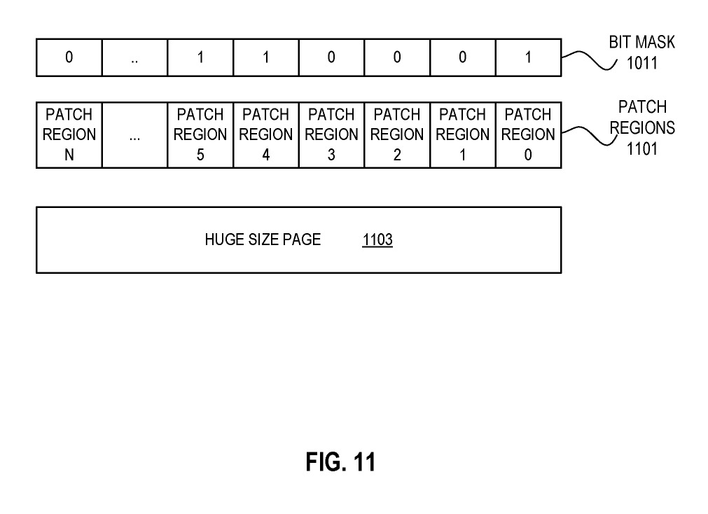

FIG. 11 illustrates bitmask usage in an embodiment. In this example, each bit of the bit mask 1011 aligns with a patch region of a plurality of patch regions 1101 that are applied to a page 1103. For a 2 MB huge size page, when the patch regions are 4 KB in size (small granularity), the bit mask 1011 is 512 bits. In some embodiments, a region covered by a bit in the bit mask 1011 is larger than the patch page to reduce the number of bits in the bit mask 1011. For example, a region can be 256 KB so that 8 bits is sufficient as a bit mask for a 2 MB huge size page. In this case, a miss in the small size page TLB 607 indicated as patched by the corresponding bit in the 2 MB TLB entry causes a lookup in the patch page table (e.g., as detailed in FIG. 9). This lookup may discover that there is no patch for the specific virtual address, and then cause the system address in the huge size page TLB to be selected (e.g., via selector circuit 605). In an embodiment, a small size page TLB entry is loaded for each such TLB miss.

In an alternative embodiment, all the patches for a selected huge size page are loaded from the patch page table into the small size page TLB whenever there is a load of a huge size page TLB entry. Further, whenever a small size page TLB entry fis evicted, the corresponding huge TLB entry is evicted as well by the MMU. In this way, there is a guarantee that if there is a hit in a patched huge size page TLB there will be no hit in the small size page TLB (that the virtual address does not correspond to a patched region of that page). That is, a hit in the huge size page TLB provides the correct system address to use.

In an embodiment, this is implemented by having a per thread patch page table. Thus, the patches for one thread can be different than those for another thread in the same address space.

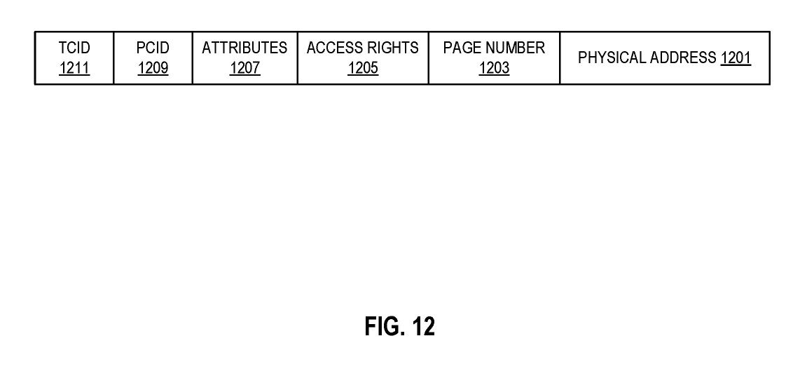

In an embodiment, this is implemented in the TLBs by having a thread context ID (TCID) as part of the processor state (similar to, but in addition to, the process context ID). FIG. 12 illustrates an example of a TLB entry in a small size page TLB according to an embodiment. As shown, the TLB entry has many of the same components of the entry of FIG. 10. These entries also include a field for the TCID. Thus, on a TLB access, a small size page TLB entry only maps to the specified virtual address if the TCID in the entry also matches to the thread TCID (and the TCID in the TLB entry is not some “global” or default value), as loaded into the processor state on context switch to this thread.

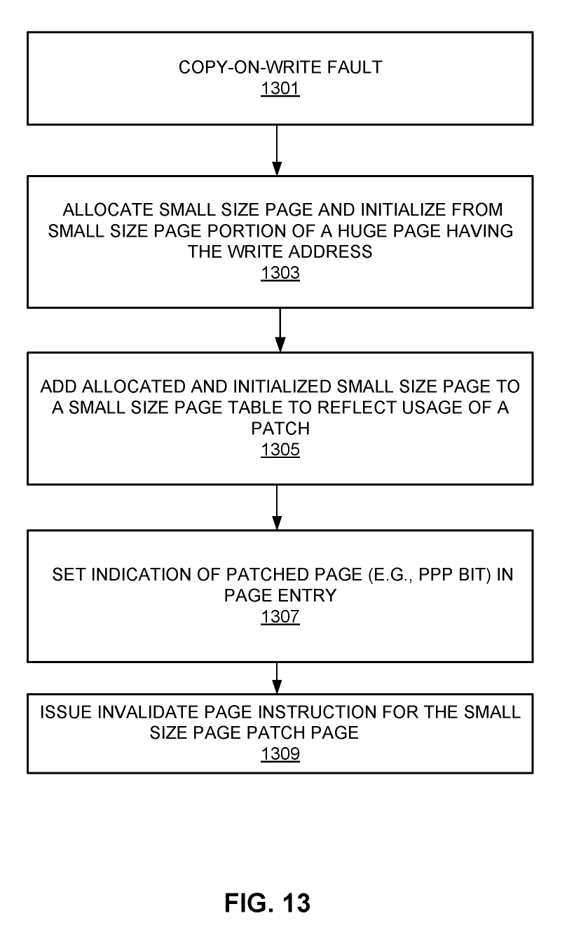

FIG. 13 illustrates an embodiment of a method for a copy-on-write flow using patch pages during thread execution. In some embodiments, the actions detailed herein are performed by MMU circuitry. For example, the actions are a part of a state machine performed by the MMU. A thread (e.g., thread TO) encounters a copy-on-write fault to a huge size page at 1301.

A small size page is allocated and initialized from a small size page portion of the huge size page containing the write address at 1303. For example, a 4k page frame is allocated and initialized from a 2 MB huge size page, or a 1 GB or 16 GB huge size page, etc.

The allocated and initialized small size page is added to a small size page page table to reflect the usage of a patch page at 1305. For example, the patch page is added to a table such as page table structures of FIG. 9. In some embodiments, separate page tables are maintained for patches.

A patch page present indication is set in the huge size page's page table structure for patched pages in a corresponding entry at 1307. For example, the PPP bit 801 of a corresponding PDE is set. In some embodiments, the corresponding huge size page table for patched pages is identified using a CR3B register.

At 1309, an invalidating page request (e.g., instruction) is issued for the small size page patch table entry and the thread is resumed. This invalidation allows for a trap from the patched page entry into a TLB. In some embodiments, the small patch TLB takes precedent over the huge size page TLB. Utilizing patch bases minimizes space and copy overhead compared to huge size page copy.

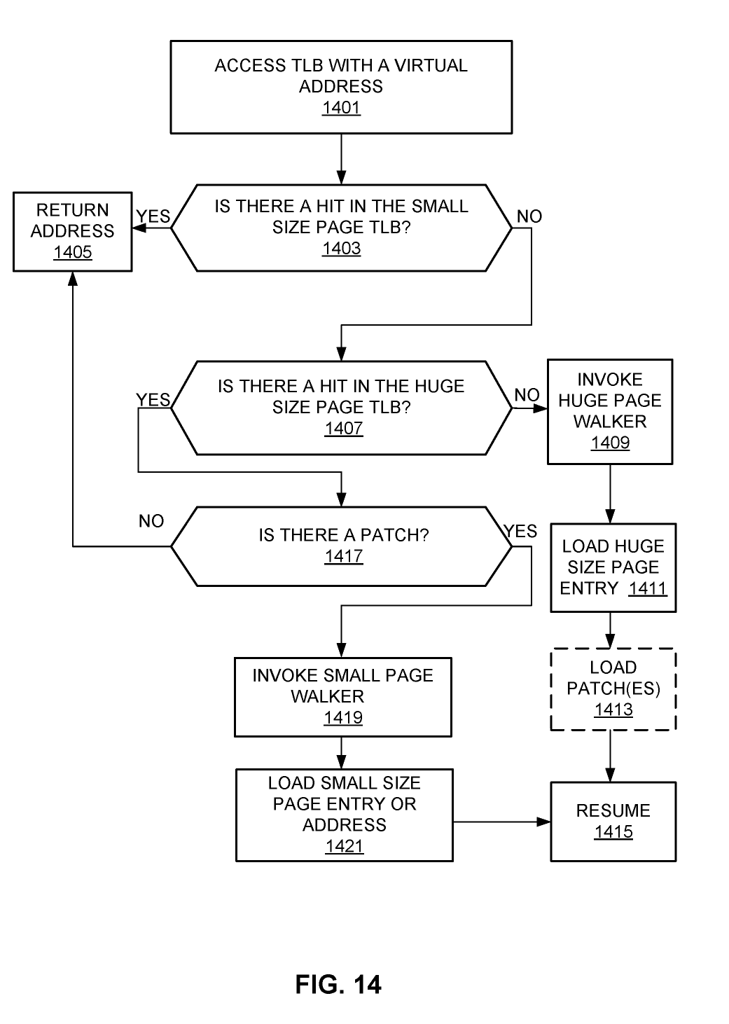

FIG. 14 illustrates an embodiment of a method for using patched pages in a MMU. In some embodiments, the actions detailed herein are a portion of a state machine executed by the MMU circuitry. Typically, this method occurs after the method of 13 has been performed. At 1401, a TLB access to a particular virtual address is made. Consequently, accesses to small size page and huge size page TLBs are made for the virtual address.

A determination of whether there is a hit in the small size page TLB is made at 1403. For example, did the search of the small size page TLB result in a hit? When there is a hit, then the address from the small size page TLB is returned at 1405. As such, the requestor can utilize this physical address. Note that in some embodiments, there is some indication that the small size page TLB is to take precedence (either the use of a PPP bit, or by default). However, in some embodiments there is not any such explicit indication that the small page TLB take precedent.

When there is not a hit, a determination of whether there is a hit in the huge size page TLB is made at 1407.

When there is a hit in the huge size page TLB, a determination of whether there is a patch page is made at 1417. For example, is the PPP bit set for the entry that had a hit? If not, then the address from the hit in the huge size page TLB is returned at 1405. When there is a patch page, a small size page table walker is invoked at 1419. The result of the page table walking is loaded as a small size page entry in the small size page TLB, or the page walker loads the address of the offset into the huge page that corresponds to the offered vritual address, if there is no patch for this particular small page portion of the huge page at 1421.

When there is not a hit in the huge size page TLB, then the huge size page table walker is invoked at 1409. The result of the page table walking is loaded as a huge size page entry in the huge size page TLB at 1411.

In some embodiments, one or more patches are loaded into the small size page TLB at 1413.

Execution of the thread is resumed at 1415 after loading the TLB entries.

Detailed below are exemplary architectures and systems that may be utilized for the above detailed instructions.

Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

Exemplary Core Architectures

In-Order and Out-of-Order Core Block Diagram

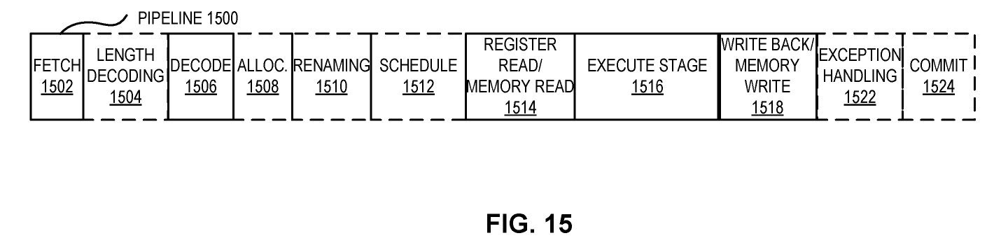

FIG. 15 is a block diagram illustrating both an exemplary in-order pipeline and an exemplary register renaming, out-of-order issue/execution pipeline according to embodiments of the invention.

In FIG. 15A, a processor pipeline 1500 includes a fetch stage 1502, a length decode stage 1504, a decode stage 1506, an allocation stage 1508, a renaming stage 1510, a scheduling (also known as a dispatch or issue) stage 1512, a register read/memory read stage 1514, an execute stage 1516, a write back/memory write stage 1518, an exception handling stage 1522, and a commit stage 1524.

Specific Exemplary In-Order Core Architecture

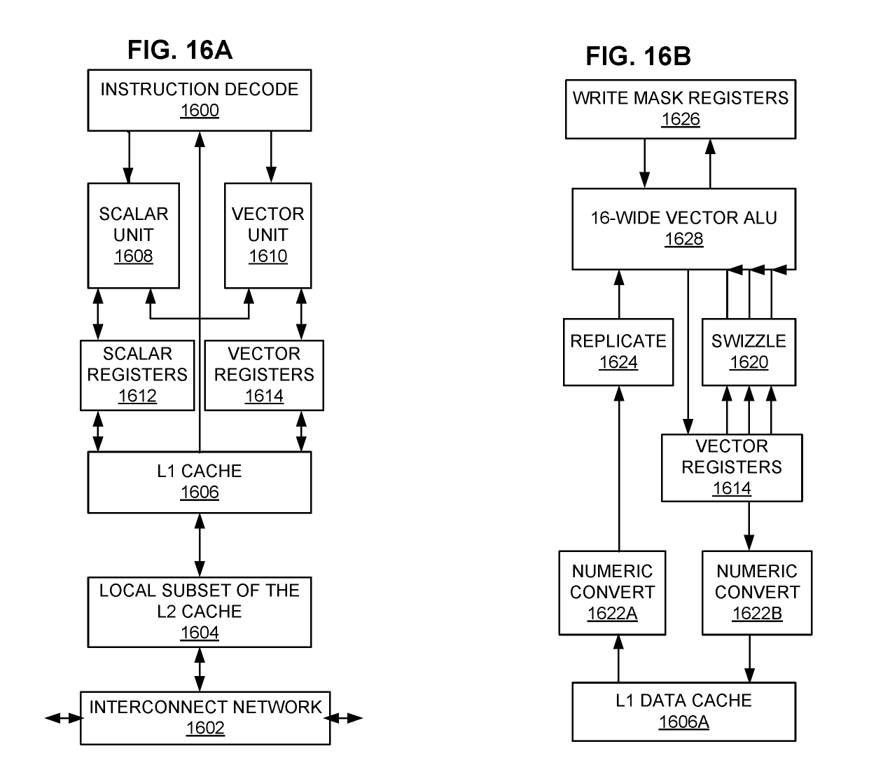

FIGS. 16A-B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 16A is a block diagram of a single processor core, along with its connection to the on-die interconnect network 1602 and with its local subset of the Level 2 (L2) cache 1604, according to embodiments of the invention. In one embodiment, an instruction decoder 1600 supports the x86 instruction set with a packed data instruction set extension. An L1 cache 1606 allows low-latency accesses to cache memory into the scalar and vector units. While in one embodiment (to simplify the design), a scalar unit 1608 and a vector unit 1610 use separate register sets (respectively, scalar registers 1612 and vector registers 1614) and data transferred between them is written to memory and then read back in from a level 1 (L1) cache 1606, alternative embodiments of the invention may use a different approach (e.g., use a single register set or include a communication path that allow data to be transferred between the two register files without being written and read back).

The local subset of the L2 cache 1604 is part of a global L2 cache that is divided into separate local subsets, one per processor core. Each processor core has a direct access path to its own local subset of the L2 cache 1604. Data read by a processor core is stored in its L2 cache subset 1604 and can be accessed quickly, in parallel with other processor cores accessing their own local L2 cache subsets. Data written by a processor core is stored in its own L2 cache subset 1604 and is flushed from other subsets, if necessary. The ring network ensures coherency for shared data. The ring network is bi-directional to allow agents such as processor cores, L2 caches and other logic blocks to communicate with each other within the chip. Each ring data-path is 1012-bits wide per direction.

FIG. 16B is an expanded view of part of the processor core in FIG. 16A according to embodiments of the invention. FIG. 16B includes an L1 data cache 1606A part of the L1 cache 1604, as well as more detail regarding the vector unit 1610 and the vector registers 1614. Specifically, the vector unit 1610 is a 16-wide vector processing unit (VPU) (see the 16-wide ALU 1628), which executes one or more of integer, single-precision float, and double-precision float instructions. The VPU supports swizzling the register inputs with swizzle unit 1620, numeric conversion with numeric convert units 1622A-B, and replication with replication unit 1624 on the memory input. Write mask registers 1626 allow predicating resulting vector writes.

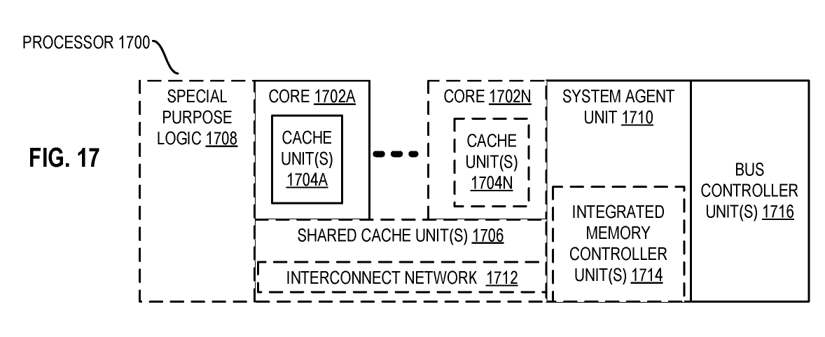

FIG. 17 is a block diagram of a processor 1700 that may have more than one core, may have an integrated memory controller, and may have integrated graphics according to embodiments of the invention. The solid lined boxes in FIG. 17 illustrate a processor 1700 with a single core 1702A, a system agent 1710, a set of one or more bus controller units 1716, while the optional addition of the dashed lined boxes illustrates an alternative processor 1700 with multiple cores 1702A-N, a set of one or more integrated memory controller unit(s) 1714 in the system agent unit 1710, and special purpose logic 1708.

Thus, different implementations of the processor 1700 may include: 1) a CPU with the special purpose logic 1708 being integrated graphics and/or scientific (throughput) logic (which may include one or more cores), and the cores 1702A-N being one or more general purpose cores (e.g., general purpose in-order cores, general purpose out-of-order cores, a combination of the two); 2) a coprocessor with the cores 1702A-N being a large number of special purpose cores intended primarily for graphics and/or scientific (throughput); and 3) a coprocessor with the cores 1702A-N being a large number of general purpose in-order cores. Thus, the processor 1700 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 1700 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 1706, and external memory (not shown) coupled to the set of integrated memory controller units 1714. The set of shared cache units 1706 may include one or more mid-level caches, such as level 2 (L2), level 3 (L3), level 4 (L4), or other levels of cache, a last level cache (LLC), and/or combinations thereof. While in one embodiment a ring based interconnect unit 1712 interconnects the integrated graphics logic 1708 (integrated graphics logic 1708 is an example of and is also referred to herein as special purpose logic), the set of shared cache units 1706, and the system agent unit 1710/integrated memory controller unit(s) 1714, alternative embodiments may use any number of well-known techniques for interconnecting such units. In one embodiment, coherency is maintained between one or more cache units 1706 and cores 1702-A-N.

In some embodiments, one or more of the cores 1702A-N are capable of multithreading. The system agent 1710 includes those components coordinating and operating cores 1702A-N. The system agent unit 1710 may include for example a power control unit (PCU) and a display unit. The PCU may be or include logic and components needed for regulating the power state of the cores 1702A-N and the integrated graphics logic 1708. The display unit is for driving one or more externally connected displays.

The cores 1702A-N may be homogenous or heterogeneous in terms of architecture instruction set; that is, two or more of the cores 1702A-N may be capable of execution the same instruction set, while others may be capable of executing only a subset of that instruction set or a different instruction set.

Exemplary Computer Architectures

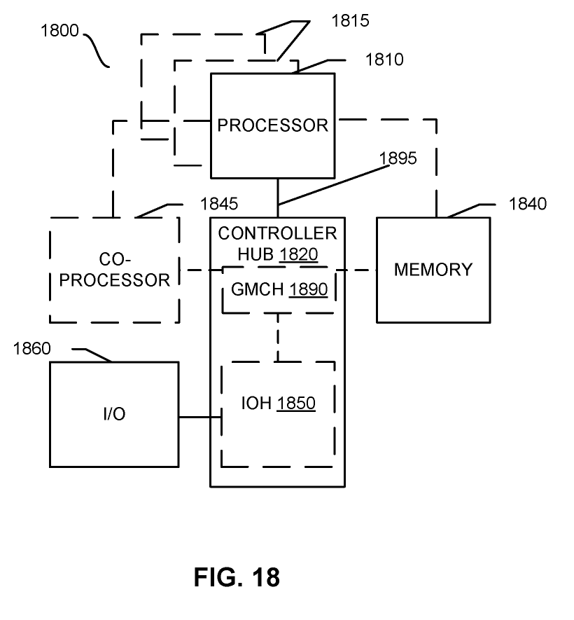

FIGS. 18-21 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 18, shown is a block diagram of a system 1800 in accordance with one embodiment of the present invention. The system 1800 may include one or more processors 1810, 1815, which are coupled to a controller hub 1820. In one embodiment the controller hub 1820 includes a graphics memory controller hub (GMCH) 1890 and an Input/Output Hub (IOH) 1850 (which may be on separate chips); the GMCH 1890 includes memory and graphics controllers to which are coupled memory 1840 and a coprocessor 1845; the IOH 1850 couples input/output (I/O) devices 1860 to the GMCH 1890. Alternatively, one or both of the memory and graphics controllers are integrated within the processor (as described herein), the memory 1840 and the coprocessor 1845 are coupled directly to the processor 1810, and the controller hub 1820 in a single chip with the IOH 1850.

The optional nature of additional processors 1815 is denoted in FIG. 18 with broken lines. Each processor 1810, 1815 may include one or more of the processing cores described herein and may be some version of the processor 1700.

The memory 1840 may be, for example, dynamic random access memory (DRAM), phase change memory (PCM), or a combination of the two. For at least one embodiment, the controller hub 1820 communicates with the processor(s) 1810, 1815 via a multi-drop bus, such as a frontside bus (FSB), point-to-point interface such as QuickPath Interconnect (QPI), or similar connection 1895.

In one embodiment, the coprocessor 1845 is a special-purpose processor, such as, for example, a high-throughput MIC processor, a network or communication processor, compression engine, graphics processor, GPGPU, embedded processor, or the like. In one embodiment, controller hub 1820 may include an integrated graphics accelerator.

There can be a variety of differences between the physical resources 1810, 1815 in terms of a spectrum of metrics of merit including architectural, microarchitectural, thermal, power consumption characteristics, and the like.

In one embodiment, the processor 1810 executes instructions that control data processing operations of a general type. Embedded within the instructions may be coprocessor instructions. The processor 1810 recognizes these coprocessor instructions as being of a type that should be executed by the attached coprocessor 1845. Accordingly, the processor 1810 issues these coprocessor instructions (or control signals representing coprocessor instructions) on a coprocessor bus or other interconnect, to coprocessor 1845. Coprocessor(s) 1845 accept and execute the received coprocessor instructions.

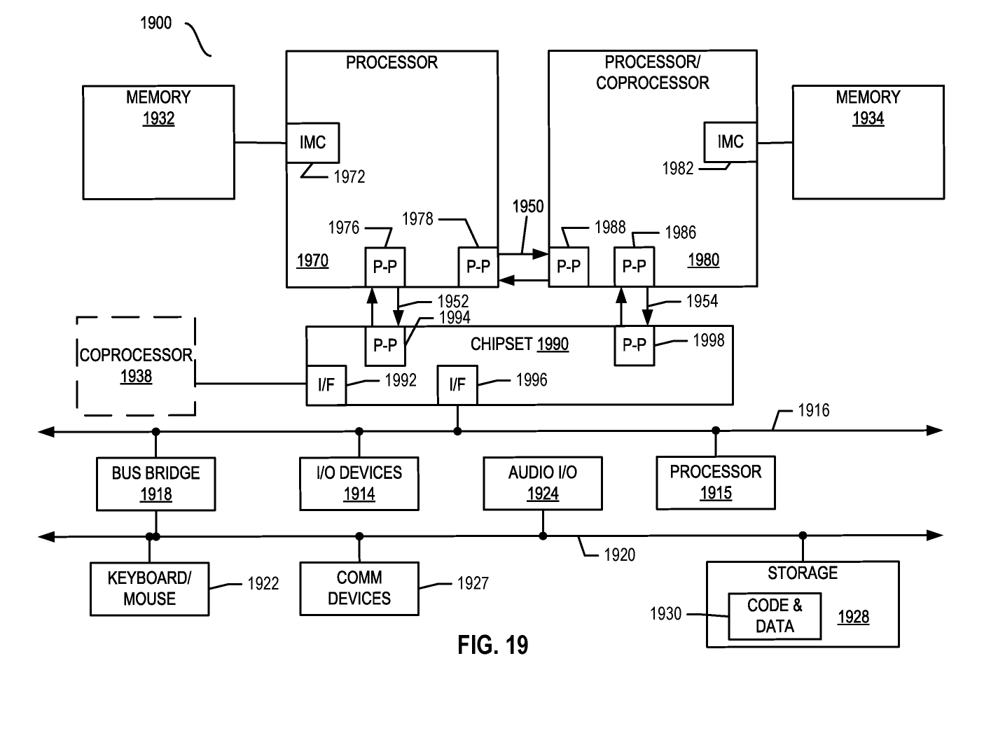

Referring now to FIG. 19, shown is a block diagram of a first more specific exemplary system 1900 in accordance with an embodiment of the present invention. As shown in FIG. 19, multiprocessor system 1900 is a point-to-point interconnect system, and includes a first processor 1970 and a second processor 1980 coupled via a point-to-point interconnect 1950. Each of processors 1970 and 1980 may be some version of the processor 1700. In one embodiment of the invention, processors 1970 and 1980 are respectively processors 1810 and 1815, while coprocessor 1938 is coprocessor 1845. In another embodiment, processors 1970 and 1980 are respectively processor 1810 coprocessor 1845.

Processors 1970 and 1980 are shown including integrated memory controller (IMC) units 1972 and 1982, respectively. Processor 1970 also includes as part of its bus controller units point-to-point (P-P) interfaces 1976 and 1978; similarly, second processor 1980 includes P-P interfaces 1986 and 1988. Processors 1970, 1980 may exchange information via a point-to-point (P-P) interface 1950 using P-P interface circuits 1978, 1988. As shown in FIG. 19, IMCs 1972 and 1982 couple the processors to respective memories, namely a memory 1932 and a memory 1934, which may be portions of main memory locally attached to the respective processors.

Processors 1970, 1980 may each exchange information with a chipset 1990 via individual P-P interfaces 1952, 1954 using point to point interface circuits 1976, 1994, 1986, 1998. Chipset 1990 may optionally exchange information with the coprocessor 1938 via a high-performance interface 1992. In one embodiment, the coprocessor 1938 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1990 may be coupled to a first bus 1916 via an interface 1996. In one embodiment, first bus 1916 may be a Peripheral Component Interconnect (PCI) bus, or a bus such as a PCI Express bus or another third generation I/O interconnect bus, although the scope of the present invention is not so limited.

As shown in FIG. 19, various I/O devices 1914 may be coupled to first bus 1916, along with a bus bridge 1918 which couples first bus 1916 to a second bus 1920. In one embodiment, one or more additional processor(s) 1915, such as coprocessors, high-throughput MIC processors, GPGPU's, accelerators (such as, e.g., graphics accelerators or digital signal processing (DSP) units), field programmable gate arrays, or any other processor, are coupled to first bus 1916. In one embodiment, second bus 1920 may be a low pin count (LPC) bus. Various devices may be coupled to a second bus 1920 including, for example, a keyboard and/or mouse 1922, communication devices 1927 and a storage unit 1928 such as a disk drive or other mass storage device which may include instructions/code and data 1930, in one embodiment. Further, an audio I/O 1924 may be coupled to the second bus 1920. Note that other architectures are possible. For example, instead of the point-to-point architecture of FIG. 19, a system may implement a multi-drop bus or other such architecture.

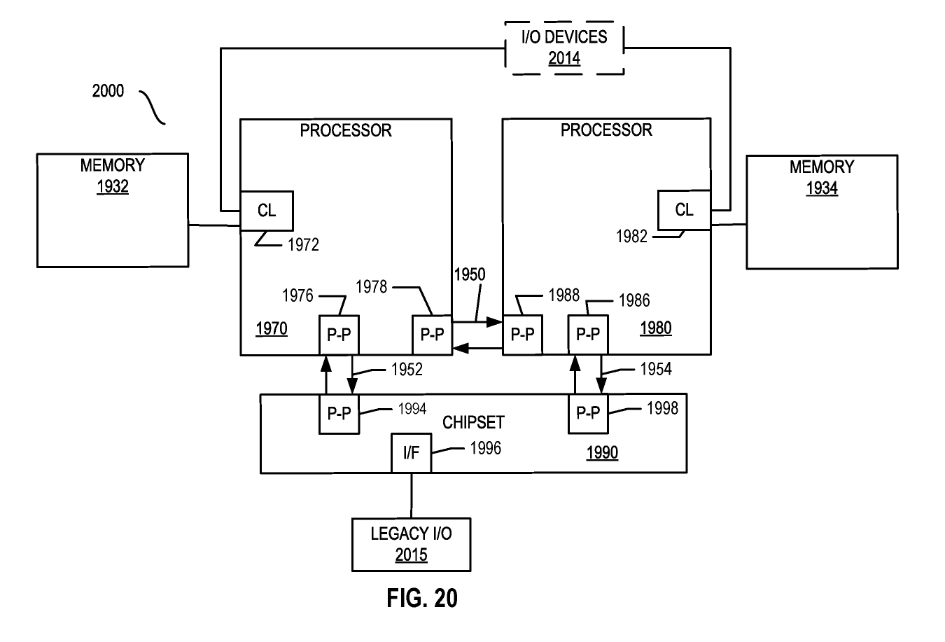

Referring now to FIG. 20, shown is a block diagram of a second more specific exemplary system 2000 in accordance with an embodiment of the present invention. Like elements in FIGS. 19 and 20 bear like reference numerals, and certain aspects of FIG. 19 have been omitted from FIG. 20 in order to avoid obscuring other aspects of FIG. 20.

FIG. 20 illustrates that the processors 1970, 1980 may include integrated memory and I/O control logic (“CL”) 1972 and 1982, respectively. Thus, the CL 1972, 1982 include integrated memory controller units and include I/O control logic. FIG. 20 illustrates that not only are the memories 1932, 1934 coupled to the CL 1972, 1982, but also that I/O devices 2014 are also coupled to the control logic 1972, 1982. Legacy I/O devices 2015 are coupled to the chipset 1990.

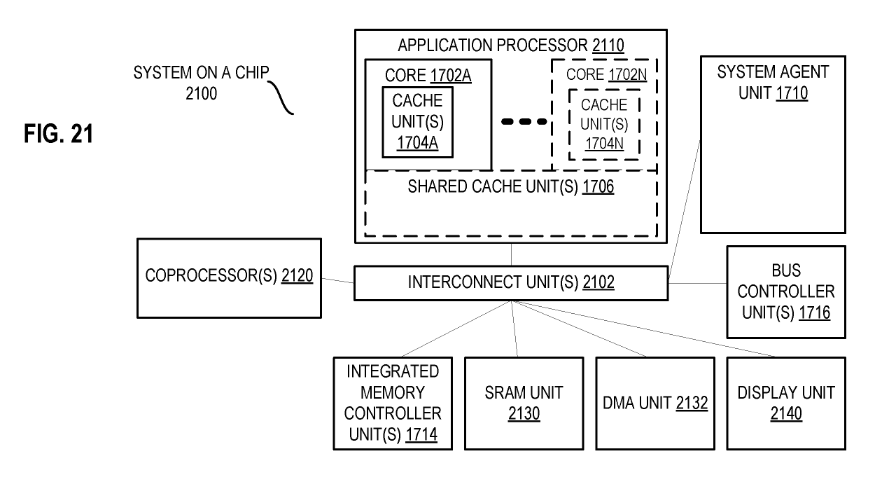

Referring now to FIG. 21, shown is a block diagram of a SoC 2100 in accordance with an embodiment of the present invention. Similar elements in FIG. 17 bear like reference numerals. Also, dashed lined boxes are optional features on more advanced SoCs. In FIG. 21, an interconnect unit(s) 2102 is coupled to: an application processor 2110 which includes a set of one or more cores 1702A-N, which include cache units 1704A-N, and shared cache unit(s) 1706; a system agent unit 1710; a bus controller unit(s) 1716; an integrated memory controller unit(s) 1714; a set or one or more coprocessors 2120 which may include integrated graphics logic, an image processor, an audio processor, and a video processor; an static random access memory (SRAM) unit 2130; a direct memory access (DMA) unit 2132; and a display unit 2140 for coupling to one or more external displays. In one embodiment, the coprocessor(s) 2120 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 1930 illustrated in FIG. 19, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMS) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

Emulation (Including Binary Translation, Code Morphing, Etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

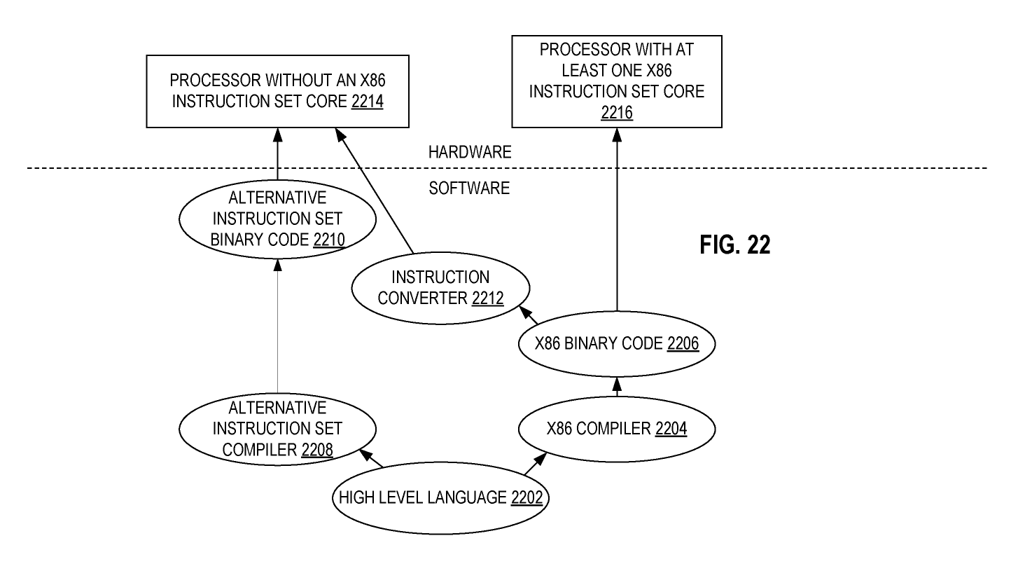

FIG. 22 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 22 shows a program in a high level language 2202 may be compiled using an x86 compiler 2204 to generate x86 binary code 2206 that may be natively executed by a processor with at least one x86 instruction set core 2216. The processor with at least one x86 instruction set core 2216 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 2204 represents a compiler that is operable to generate x86 binary code 2206 (e.g., object code) that can, with or without additional linkage processing, be executed on the processor with at least one x86 instruction set core 2216. Similarly, FIG. 22 shows the program in the high level language 2202 may be compiled using an alternative instruction set compiler 2208 to generate alternative instruction set binary code 2210 that may be natively executed by a processor without at least one x86 instruction set core 2214 (e.g., a processor with cores that execute the MIPS instruction set of MIPS Technologies of Sunnyvale, Calif. and/or that execute the ARM instruction set of ARM Holdings of Sunnyvale, Calif.). The instruction converter 2212 is used to convert the x86 binary code 2206 into code that may be natively executed by the processor without an x86 instruction set core 2214. This converted code is not likely to be the same as the alternative instruction set binary code 2210 because an instruction converter capable of this is difficult to make; however, the converted code will accomplish the general operation and be made up of instructions from the alternative instruction set. Thus, the instruction converter 2212 represents software, firmware, hardware, or a combination thereof that, through emulation, simulation or any other process, allows a processor or other electronic device that does not have an x86 instruction set processor or core to execute the x86 binary code 2206.

Exemplary embodiments are as follows:

### Example 1

A method comprising allocating a small size page and initializing the small size page; adding the allocated and initialized small size page to a small size page table to reflect usage of a patch of the huge size page; and setting an indication of usage of the patch in a page entry associated with the huge size page.

### Example 2

The method of example 1, wherein the patch is a virtual memory page.

### Example 3

The method of any of examples 1-2, wherein the small size page is a 4 kilobyte patch.

### Example 4

The method of example 3, wherein the huge size page at least 2 megabytes in size.

### Example 5

The method of any of examples 1-4, wherein the indication is a bit in a page table entry.

### Example 6

The method of any of examples 1-5, further comprising: determining that there is a hit in a small size page translation lookaside buffer and using a returned address from the hit as the physical address.

### Example 7

The method of example 6, wherein the small size page translation lookaside buffer is given precedence over a huge size page translation lookaside buffer.

### Example 8

The method of example 7, wherein the precedence is determined based on the indication of usage of the patch.

### Example 9

The method of example 6, wherein patch usage is per thread.

### Example 10

The method of example 9, wherein a thread context identifier is included in entries of the small size page translation lookaside buffer.

### Example 11

The method of any of examples 1-10, wherein the small size page is allocated from a huge page.

### Example 12

The method of any of examples 1-10, wherein the small size page is allocated by an input/output device.

### Example 13

An apparatus comprising a first paging structure associated with a huge size page; and a second paging structure associated with a small size page, wherein the second paging structure is to store address information for a patch of a huge size page to be used instead of the huge size page when enabled.

### Example 14

The apparatus of example 13, wherein the patch is a virtual memory page.

### Example 15

The apparatus of any of examples 13-14, wherein the small size page is a 4 kilobyte patch of the huge size page.

### Example 16

The apparatus of example 15, wherein the huge size page at least 2 megabytes in size.

### Example 17

The apparatus of any of examples 13-16, wherein the first paging structure is to include an indication of patch usage as a bit in a page table entry.

### Example 18

The apparatus of example 13, further comprising: a small size page translation lookaside buffer to cache address information for the second paging structure.

### Example 19

The apparatus of example 18, wherein the small size page translation lookaside buffer is given precedence over a huge size page translation lookaside buffer.

### Example 20

The apparatus of example 19, wherein the precedence is determined based on the indication of usage of the patch.

### Example 21

The apparatus of example 18, wherein patch usage is per thread.

### Example 22

The apparatus of example 21, wherein a thread context identifier is included in entries of the small size page translation lookaside buffer.

### Example 23

The apparatus of any of examples 13-22, wherein the first and second paging structures are a part of a same paging structure.

### Example 24

The apparatus of any of examples 13-22, wherein the first and second paging structures are a part of separate paging structures.

### Example 25

The apparatus of any of examples 13-23, further comprising memory to store pages.

What is claimed is:

1. A method comprising:
allocating a small size page and initializing the small size page;
adding the allocated and initialized small size page to a small size page table to reflect usage of a patch of the huge size page; and
setting an indication of usage of the patch in a page entry associated with the huge size page.

2. The method of claim 1, wherein the patch is a virtual memory page.

3. The method of claim 1, wherein the small size page is a 4 kilobyte patch.

4. The method of claim 3, wherein the huge size page at least 2 megabytes in size.

5. The method of claim 1, wherein the indication is a bit in a page table entry.

6. The method of claim 1, further comprising:
determining that there is a hit in a small size page translation lookaside buffer and using a returned address from the hit as the physical address.

7. The method of claim 6, wherein the small size page translation lookaside buffer is given precedence over a huge size page translation lookaside buffer.

8. The method of claim 7, wherein the precedence is determined based on the indication of usage of the patch.

9. The method of claim 6, wherein patch usage is per thread.

10. The method of claim 9, wherein a thread context identifier is included in entries of the small size page translation lookaside buffer.

11. The method of claim 1, wherein the small size page is allocated from a huge page.

12. The method of claim 1, wherein the small size page is allocated by an input/output device.

13. An apparatus comprising:
a first paging structure associated with a huge size page; and
a second paging structure associated with a small size page, wherein the second paging structure is to store address information for a patch of a huge size page to be used instead of the huge size page when enabled.

14. The apparatus of claim 13, wherein the patch is a virtual memory page.

15. The apparatus of claim 13, wherein the small size page is a 4 kilobyte patch of the huge size page.

16. The apparatus of claim 15, wherein the huge size page at least 2 megabytes in size.

17. The apparatus of claim 13, wherein the first paging structure is to include an indication of patch usage as a bit in a page table entry.

18. The apparatus of claim 13, further comprising:
a small size page translation lookaside buffer to cache address information for the second paging structure.

19. The apparatus of claim 18, wherein the small size page translation lookaside buffer is given precedence over a huge size page translation lookaside buffer.

20. The apparatus of claim 19, wherein the precedence is determined based on the indication of usage of the patch.

21. The apparatus of claim 18, wherein patch usage is per thread.

22. The apparatus of claim 21, wherein a thread context identifier is included in entries of the small size page translation lookaside buffer.

23. The apparatus of claim 13, wherein the first and second paging structures are a part of a same paging structure.

24. The apparatus of claim 13, wherein the first and second paging structures are a part of separate paging structures.
